(19) United States
(12) Patent Application Publication
(10) Pub. No.: US 2023/0272495 A1
(43) Pub. Date: Aug. 31, 2023

(54) METHOD FOR OPERATING A METALLURGIC PLANT FOR PRODUCING IRON PRODUCTS

(71) Applicant: PAUL WURTH S.A., Luxembourg (LU)

(72) Inventors: Jan KRULL, Varazze (IT); Cristiano CASTAGNOLA, Genova (IT); Stefano MAGNANI, Genova (IT)

(21) Appl. No.: 18/018,351

(22) PCT Filed: Jul. 23, 2021
(86) PCT No.: PCT/EP2021/070627

§ 371 Date: Jan. 27, 2023

(30) Foreign Application Priority Data
Jul. 28, 2020 (LU) LU101960

(51) Int. Cl. C21B 13/00

(52) U.S. Cl. CPC C21B 13/0073; C21B 2100/22; C21B 2100/26; C21B 2100/282; C21B 2200/00

(57) ABSTRACT

A method of operating a metallurgic plant for producing iron products includes the following steps, wherein the metallurgic plant includes a direct reduction plant and an ironmaking plant, the metallurgic plant:
feeding an iron ore charge into the direct reduction plant to produce direct reduced iron products,
operating the ironmaking plant to produce pig iron, wherein biochar is introduced into the ironmaking plant as reducing agent, and whereby the ironmaking plant generates offgas containing CO and CO2, and treating offgas from the ironmaking plant in a hydrogen enrichment unit to form a hydrogen-rich stream and a CO2-rich stream. The hydrogen-rich stream is fed directly or indirectly to the direct reduction plant. The CO2-rich stream is converted to be valorized in the direct reduction plant.

A corresponding metallurgic plant is also related.

### CROSS-REFERENCE TO RELATED APPLICATIONS

The present application is a 35 U.S.C. § 371 National Stage patent application of International patent application PCT/EP2021/070627, filed on 23 Jul. 2021, which claims priority to Luxembourg patent application 101960, filed on 28 Jul. 2020.

### TECHNICAL FIELD

The present disclosure generally relates to the field of iron metallurgy and in particular to a metallurgic plant and method for producing iron products. The disclosure more specifically relates to iron metallurgy based on the iron ore direct reduction process.

### BACKGROUND

Industrial processes contribute significantly to global CO₂ emissions and the current iron and steel manufacturing process is very energy and carbon intensive. With the Paris Accord and near-global consensus on the need for action on emissions, it is imperative that each industrial sector looks into the development of solutions towards improving energy efficiency and decreasing CO₂ output.

One technology developed to reduce the carbon footprint during steel production is the iron ore direct reduction process. Although annual direct reduction iron production remains small compared to the production of blast furnace pig iron, it is indeed very attractive for its considerably lower CO₂ emissions, which are 40 to 60% lower for the direct reduction electric-arc furnace (EAF) route, compared to the blast furnace, basic oxygen route.

In a direct reduction shaft furnace, a charge of pelletized or lump iron ore is loaded into the top of the furnace and is allowed to descend, by gravity, through a reducing gas. The reducing gas, mainly comprised of hydrogen and carbon monoxide (syngas), flows upwards, through the ore bed. Reduction of the iron oxides occurs in the upper section of the furnace, conventionally at temperatures up to 950° C. and even higher. The solid product, called direct reduced iron (DRI) is typically charged hot into Electric Arc Furnaces, or is hot briquetted (to form HBI).

In most of the existing application of DRI the above-mentioned syngas is generated via reforming of natural gas; in some cases, a suitable gas is already available, whereby natural gas is not required.

As is known in the art, the DRI and like products are charged in a blast furnace or an ironmaking plant, or a smelting furnace such as an EAF to produce pig iron or steel.

WO2017/046653 discloses a method and apparatus for the direct reduction of iron ores utilizing coal-derived gas. The method for producing DRI utilises a synthesis gas containing a relatively high content of CO, with a ratio H2/CO lower than about 0.5, in a reduction system comprising a reduction reactor from which a hot stream of reducing gas is withdrawn as a top gas, a heat-exchanger wherein heat is taken from the hot top gas and transferred to a stream of liquid water; and a gas humidifier. A melter-gasifier is used to produce slag and pig iron from iron ore thereby generating offgas containing CO and CO2. Offgas exiting the melter-gasifier is treated (cleaning, compression . . . ) before being fed to two successive CO-conversion units and to increase the amount of H₂ and CO₂ in the stream of gas. This stream is then fed to a CO₂-removal unit, thereby forming a CO₂-rich stream and a hydrogen-rich stream. The hydrogen-rich stream is fed to the reduction reactor. The CO₂-rich stream is discarded.

EP 0997 693 relates to a method for integrating a blast furnace and a direct reduction reactor using cryogenic rectification. The cleaned blast furnace gas is fed to a water-gas shift reactor. The resulting stream of gas containing mainly H₂ and CO₂ is then fed to an acid gas removal unit and a methanation unit. A cryogenic unit is used to separate nitrogen from hydrogen. Carbon dioxide is removed from the system, in hot potassium carbonate system or in a pressure swing adsorption system.

The object of the present disclosure is to provide an improved approach for the production of direct reduced iron products, which is in particular more environment friendly.

### SUMMARY

This object is achieved by a method as claimed in claim 1.

The present disclosure relates to a method of operating a metallurgic plant for producing iron products, comprising:
feeding an iron ore charge into a direct reduction plant to produce direct reduced iron products;
operating the ironmaking plant to produce pig iron, wherein biochar is introduced into the ironmaking plant as reducing agent, and whereby the ironmaking plant generates offgas containing CO and CO₂;
treating offgas from the ironmaking plant in a hydrogen enrichment unit to form a hydrogen-rich stream and a CO₂-rich stream;
wherein at least part (i.e. a portion or up to 100%) of the hydrogen-rich stream is fed to the direct reduction plant.

The present disclosure provides an optimal configuration of direct reduction plant and ironmaking plant, when located on the same site, and based on green energy sources, in particular biomass. Advantageously, the biochar is produced on site by a biomass pyrolysis unit from biomass material.

According to the disclosure, biochar is used as reducing agent in the ironmaking plant, and offgas of the ironmaking plant (in part or entirely) is then converted into a gas stream that is valorized in the direct reduction plant.

The ironmaking plant receives a charge of iron bearing materials, which—as will be further explained—may have various origins, and in particular may originate from the DR plant.

Through the various embodiments, a synergy of gases as well as of solid materials is achieved:
the direct reduction plant exploits the offgases from the ironmaking plant;
the ironmaking plant can benefit from dust and residues from the DR plant. It shall thus be appreciated that waste material from the DR plant can be recycled in the ironmaking furnace.
the ironmaking plant can also/alternatively benefit from DRI (direct reduced iron)/HDRI (hot DRI)/HBI (hot briquetted iron) produced by the direct reduction plant.

A merit of the disclosure is the optimized and balanced connection between the direct reduction plant and the ironmaking plant, as well as the fact that both are based on green energy/green fuel.

Accordingly, the iron products output by the direct reduction plant can be referred to as green metallic products.

In the present text, DR means ‘direct reduction’ or ‘direct reduced’ depending on the context.

At least part of the hydrogen-rich stream produced in the hydrogen enrichment unit may be directly forwarded to the direct reduction plant, where it can be used as gas or fuel for metallurgical purposes and/or for heating purposes. Hence, the hydrogen-rich stream may be part of a of a reducing gas stream and/or of a fuel gas stream.

Preferably, at least part (i.e. a portion or 100%) of the CO₂-rich stream is converted to be valorized in the direct reduction plant. Depending on embodiments, the CO₂-rich stream may in particular be converted to form a syngas or a natural gas (gas stream mainly composed of methane). This is particularly advantageous since the proposed metallurgical plant is thus capable of recycling the CO₂ for the benefit of the direct reduction plant. Hence the CO₂ is not discarded or valorized elsewhere, but directly on site.

By contrast, in the methods proposed by WO2017/046653 and EP 0997 693 the carbon dioxide is removed from the system and not converted to be valorized in the DR plant.

Advantageously, the CO₂-rich stream may be fed to a water electrolysis unit, preferably further supplied with a stream of steam, to form a syngas stream that is delivered to the direct reduction plant. This syngas stream typically mainly contains hydrogen and carbon monoxide, and can thus be valorized in the direct reduction plant, as reducing gas and/or as fuel gas. The combined content of H₂ and CO in the syngas stream may be of at least 60% v, preferably at least 70 or 80% v.

In embodiments, at least part of the hydrogen-rich stream is delivered indirectly to the direct reduction plant. The term indirectly herein implies that the hydrogen-rich stream is transformed/converted on its way to the direct reduction plant in a gas stream that can be valorized in the direct reduction plant. For example, the hydrogen-rich stream and the CO₂-rich stream may be forwarded from the hydrogen enrichment unit to a methanation unit to form a methane stream. This stream is delivered to the direct reduction plant to be used as part of a reducing gas stream and/or as part of as part of a fuel gas stream.

In embodiments, the hydrogen-rich stream is valorized, directly or indirectly, into the direct reduction plant to be used as part of process gas. Herewith the reducing gas is introduced into the DR plant, in order to order to reduce the pellets/agglomerates of iron bearings. In the context of the disclosure, the pellets/agglomerates do normally only comprise iron bearings (e.g. iron ore particles/fines). The pellets/agglomerates do normally not contain added solid reducing material (char/coal or carbonaceous materials), except for traces or unavoidable amounts.

In embodiments, the direct reduction plant may comprise a direct reduction furnace or reactor, and additional equipment depending on the direct reduction technology that is implemented. For example, the DR plant may comprise, in addition to the DR furnace, a reformer and a heat recovery system. In such case the methane stream can be used in part as fuel gas for heating the reformer and/or in part as process gas, through reforming, and/or by direct injection into the DR furnace.

In embodiments, a water electrolysis unit is associated with the methanation unit, whereby a steam stream output from the methanation unit is fed to the electrolysis unit to form an auxiliary hydrogen stream that is fed back to the methanation unit. This provides a convenient way of valorizing the water vapour resulting from the methanation process. Optionally, an additional steam stream, preferably from a green energy source, may be introduced in the water electrolysis unit.

Where ironmaking plant offgas stream is intended to be valorized as metallurgical gas (reducing gas) in the direct reduction shaft furnace, it is desirable to remove the nitrogen content. For this purpose, a portion of the offgas stream from the ironmaking plant may be treated in a nitrogen rejection unit before being forwarded to the hydrogen enrichment unit. In embodiments, the nitrogen rejection unit can be arranged on the outlet flow of the hydrogen enrichment unit, instead of its inlet flow.

The present disclosure can be implemented with existing equipment well known in the metallurgical field. For example, the direct reduction plant, ironmaking plant, biomass pyrolysis unit can be based on any appropriate technology. The gas treatment systems used in the disclosure are also well known, being them used in the metallurgical field or more generally in the chemical field.

For example, the hydrogen enrichment unit can be based on a variety of technologies. In particular, the hydrogen enrichment unit may comprise a water-gas shift reactor.

Biomass pyrolysis units are used in a variety of fields. When operating under so-called ‘slow pyrolysis’ they produce biochar and biogas that can be used as carbonaceous material for heating and other purposes, in particular for metallurgical applications. In the context of the present application, the term “biochar” is used to designates solid pyrolysis products that can be used as reducing agent in the ironmaking plant, and which are conventional referred to as biochar, biocoal or biocoke. The ironmaking plant is fed with biochar as reducing agent. In this context, the biochar represents the major part of the reducing agent, namely at least 70%, 80%, 90% (by weight) and preferably up to 100%.

Nitrogen rejection units are conventionally used in the field of natural gas production.

Water electrolysis unit are also conventional and used to convert water into hydrogen.

The DR plant may implement different technologies. In embodiments, it comprises a shaft furnace, a reformer and heat recovery systems. In other embodiments, it comprises a shaft furnace, a heater and a CO₂ removal unit (i.e. no additional reformer). Such DR plants may operate with natural gas and/or with reducing streams. These are only examples and the skilled person will know how to select appropriate reduction processes.

Likewise, the ironmaking plant may implement any appropriate technologies.

In general, the ironmaking plant may include a blast furnace or a smelt-reduction reactor, both fed with biochar as reducing agent.

A smelt reduction reactor typically includes a counter-current reactor fed with a mixture of iron bearings (iron bearing materials) and solid reducing agents. The iron bearings may often typically be in the form of lump ore, pellets or fines. The solid reducing agents conventionally comprise coal or carbon, however in the context of the disclosure biochar is used as reducing agent. As it is known, smelting reduction is used to produce liquid hot metal similar to the blast furnace but without dependency on coke. It requires little preparation of iron oxide feed and uses coal (or carbon), oxygen and/or electrical energy.

In embodiments, the ironmaking plant includes a relatively short-height counter-current reactor fed with a mixture of iron bearings (iron bearing materials) and solid reducing agents. The iron bearings are typically agglomerated, starting from fine ores, adding a portion of reducing agents into them, to facilitate ironmaking reactions. The materials are charged into the reactor from its top, via dedicated channels. Air, possibly enriched with oxygen, as well as gaseous reducing agents are blown from the lower part of the reactor. Pig iron and slag are tapped from the bottom. Such kind of smelt reduction reactor with vertical stacks of materials is e.g. disclosed in WO 2019/110748, incorporated herein by reference. As it will be known by those skilled in the art, such short height reactor is based upon a low-pressure moving bed reduction, is flexible with regard to the type of iron bearing and carbon bearing raw materials which it can process. The ability of the process to smelt either pellets or briquettes, or even mixed charges of both, provides means of using a wide range of alternative feed materials.

It may be noted here that this kind of short height, smelt reduction reactor generates substantial quantities of offgas, comparatively more than other technologies of smelt reduction, hence making it particularly suitable for use in the context of the disclosure, i.e. for using the offgas in a direct reduction plant. In other words, the short height, smelt reduction reactor provides a viable solution to the inventive concept where the ironmaking plant offgas should be able to provide the major source of gas for operating the direct reduction plant.

Likewise, the blast furnace generates substantial amounts of gas.

In the context of the disclosure, it is desirable that the offgas of the ironmaking plant has a combined CO and CO₂ content of at least 25% v, preferably more than 30, 35 or 40 vol. %. Preferably, the CO content is of at least 20, 25 or 30 vol. %.

As will be apparent to those skilled in the art, some smelt reduction furnaces (such as e.g. the above-mentioned short-height counter-current reactor or a blast furnace) may generate significant amounts of nitrogen. In such case the use of nitrogen rejection unit is recommended to remove the nitrogen from the offgas stream.

The present disclosure, through its various possible embodiments, brings a number of benefits:
Production of pig iron, DRI (under various forms) and or steel based on biomass/green energy.
Synergy of two ironmaking technologies, where the direct reduction plant exploits the offgases of the ironmaking plant, completely based on biomass/green energy, becoming therefore itself based on biomass/green energy
Operation of the direct reduction plant making use of the offgases of the ironmaking plant without requiring any CO₂ removal from such offgases.
Operation of the direct reduction plant making use of the offgases of the ironmaking plant without requiring any CO₂ removal step neither N₂ removal from such offgases.
Connection of two ironmaking technologies where the ironmaking plant is capable to make use of the fines and residues of the direct reduction plant. In particular, the inventive configuration allows for dusts, fines, and other residues from the DR plant to be fed to the ironmaking plant as part of the charge to be melted therein. These materials, i.e. dusts, fines, and other residues, can, depending on the ironmaking plant technology, be recycled in bulk (small particulate form), or as agglomerates (of variable size). This capacity of easily recycling dusts, fines, and other residues from the DR plant on the same site into the ironmaking plant is very advantageous, and is particularly easy to implement with the above mentioned smelt reduction comprising a short-height counter-current reactor.
Configuration of two ironmaking technologies where the production of DRI in direct reduction plant can be a by-product of the ironmaking plant, whoever with the plants connected in such a way that the DR plant can also operate when the ironmaking plant is not working.

According to another aspect, the disclosure also concerns a metallurgic plant as recited in claim 25.

The above and other embodiments are recited in the appended dependent claims.

### BRIEF DESCRIPTION OF THE DRAWINGS

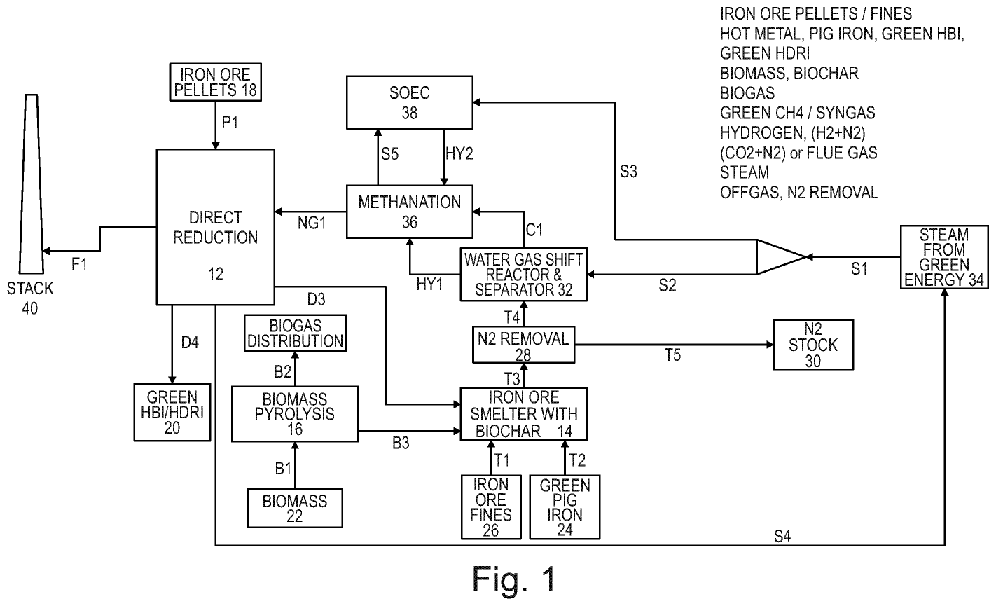

Further details and advantages of the present disclosure will be apparent from the following detailed description of not limiting embodiments with reference to the attached drawings, wherein FIGS. 1 to 4 are diagrams illustrating four different embodiments of metallurgical plants implementing the present method.

In the Figures, unless otherwise indicated, same or similar elements are designated by same reference signs.

### DETAILED DESCRIPTION OF THE DRAWINGS

FIG. 1 shows a first diagram of a plant 10 for implementing the present method. The two main components of the plant 10 are a direct reduction plant 12 and an ironmaking plant 14. Plant 10 further includes a biomass pyrolysis unit 16 that produces biochar used in the ironmaking plant 14 as reducing agent.

As will be seen through the various embodiments, the proposed plant layouts provide an optimal configuration for the combination of direct reduction plant 12 and ironmaking plant 14, based on green energy sources. In all embodiments, there is a synergy of gases (direct reduction plant exploiting offgas from the ironmaking plant) as well as of solid materials (ironmaking plant can benefit from dust and residues as well as from DRI/HRDI/HBI produced by DR furnace).

Direct reduction plant 12 is of conventional design. In this embodiment, its core equipment includes (not limiting to) a vertical shaft with a top inlet and a bottom outlet, a reformer, and a heat recovery system (not shown). A charge of iron ore 18, in lump and/or pelletized form, is loaded into the top of the furnace and is allowed to descend, by gravity, through a reducing gas; typically, mechanical equipment is installed to facilitate solid descent. The charge remains in the solid state during travel from inlet to outlet. The reducing gas is introduced laterally in the shaft furnace, at the basis of a reduction section, flowing upwards, through the ore bed. The reducing atmosphere comprises mainly H₂ and CO. Reduction of the iron oxides occurs in the upper section of the furnace, at temperatures up to 950° C. and higher. Depending on embodiments, the shaft furnace may comprise a transition section below the reduction section; this section is of sufficient length to separate the reduction section from the cooling section, allowing an independent control of both sections.

However, according to recent practice, the shaft furnace does typically not include a cooling section but an outlet section (directly below the reduction section). The solid product of the shaft furnace is thus typically discharged hot. It can then be:
1) charged hot into downstream steelmaking facility (EAF,SAF);
2) hot briquetted to form HBI;
3) cooled in a separate vessel as Cold DRI;
4) a combination of the three previous.

The core of ironmaking plant 14 is here a conventional pig iron production plant, with a relatively short-height counter-current reactor, fed with a mixture of iron bearings (iron bearing materials) and solid reducing agents. The iron bearings are typically agglomerated, starting from fine ores, adding a portion of reducing agents into them, to facilitate ironmaking reactions. The materials are charged into the pig iron reactor from its top, via dedicated channels. Air, eventually enriched with oxygen, as well as gaseous reducing agents are blown from the lower part of the reactor. Pig iron and slag are tapped from the bottom (box 24). The reactor may comprise an upper stack for the filler (iron bearings) on top of a lower stack. Solid fuel feeders are arranged around the junction between the upper and lower stacks, to supply fuel filler. Fuel is also introduced centrally via a hood positioned centrally on top of the upper stack. The various filler materials are thus charged in vertical stacks.

Such kind of smelt reduction reactor with vertical stacks of materials is e.g. disclosed in WO 2019/110748, incorporated herein by reference. The use of such kind of smelt reduction reactor is designed to operate with coal/carbon reductants, and is adapted to operate with biochar. It also allows great flexibility on the charging of iron bearings, also allowing recycling of dusts, fines, and other residues from the DR plant that may be introduced, in bulk (particles) or agglomerated form, into the smelt reduction reactor.

The biomass pyrolysis unit 16 is here also conventional. The operating principle is the pyrolysis: biomass is heated in (almost) absence of oxygen, which produces three distinct phases, respectively called char (solid), tar or bio-oil (liquid) and syngas (non-condensable gases). The product distribution among the three phases depends on the operating parameters, mainly sample size, residence time and temperature. In the context of the disclosure, a so-called slow pyrolysis (or carbonization) is particularly considered, operating at temperatures around 400 to 500° C. with relatively long residence time, whereby the main product is char. The pyrolysis unit 16 may generally include a reactor that is heated by means of electrical energy.

The raw biomass material 22 introduced into pyrolysis unit 16 can be diverse. It is typically a material qualifying as biomass fuel and may include:
i) woody biomass and by-products of the wood industry: wood lumps, wood chips and all other products of the wood industries (sawdust, sawmill wastes . . . );
(ii) products of the farming sector: energy crops (willow, miscanthus, corn . . . ) as well as crop residues (straw, bagasse, hulls . . . );
(iii) organic by-products of the industry: such as papermilll sludge, or wastes from the food-processing industry (FPI),
(iv) organic wastes: common wastes, farm effluents or other urban wastes (sewage sludges);
and combinations thereof.

From the biomass 22, the pyrolysis unit 16 generates two streams:
Biogas B2, which may be conveyed to a gas distribution network
Char B3 (e.g. biochar, biocoal or biocoke) that is routed to the ironmaking plant 14.

Conveying of the char to the ironmaking plant 14 is done in any appropriate way, e.g. by means of conveyors, rail, buckets, etc.

At the ironmaking plant 14, a charge comprising the biochar B3 and iron ore fines T1 (box 26) is used. Iron ore fines T1 are suitably agglomerated, if required, before being charged into plant 14; this can include several processing of iron ore fines, also with use of part of the biochar B3. In this embodiment, a flow D3 of dusts, fines, and other residues from DR plant 12, are used to replace a portion of T1 in the agglomeration process. Hence a portion of the charge of the ironmaking plant consists of waste materials of the DR plant 12.

The biochar B3 acts as reducing agent, thereby enabling reduction reactions required to remove oxygen from the iron bearing materials.

The offgas stream of ironmaking plant 14 is noted T3 and mainly contains CO, CO₂, Hz, H₂O and N₂. In general, the combined CO and CO₂ content in the offgas may represent at least 25% v, preferably more than 30, 35 or 40% v.

Table 1 below gives an exemplary composition of the various gas flows for the embodiment of FIG. 1.

TABLE 1
Material flows of the configuration with methanation for NG DRI.

| Pig Iron (T2) | | | Steam from DR plant (S4) | | | CO2 from WGS (C1) | | |
|---|---|---|---|---|---|---|---|---|
| Flowrate | 1 | ton | Flowrate | 558.8 | Nm3 | Flowrate | 590.5 | Nm3 |
| Composition | 94.64 | Fe % w | Steam to WGS (S2) | | | Composition | 95 | CO2% v |
| | 3.50 | C % w | Flowrate | 340 | Nm3 | | 5 | N2% v |
| Iron Ore Fines (T1) | | | Steam to SOEC (S3) | | | H2 from WGS (HY1) | | |
| Flowrate | 1.440 | ton | Flowrate | 1033 | Nm3 | Flowrate | 624.2 | Nm3 |
| Composition | 65 | Fe % w | Steam from Methanation (S5) | | | | 83.31 | H2% v |
| | 30 | O % w | Flowrate | 1122 | Nm3 | Composition | 15.86 | CO2% v |
| Fines from DR (D3) | | | Offgas (T3) | | | | 0.83 | N2% v |
| Flowrate | 0.060 | ton | Flowrate | 2000 | Nm3 | SOEC out H2 (HY2) | | |
| | 95.5 | Fe % w | | 24 | CO % v | Flowrate | 1930.6 | Nm3 |
| Composition | 3.5 | C % w | | 9 | CO2% v | Composition | 89.30 | H2% v |
| | 1 | O % w | Composition | 2 | H2% v | | 10.70 | H2O % v |
| Iron Ore (P1) | | | | 7 | H2O % v | Natural Gas (NG1) | | |
| Flowrate | 2.525 | ton | | 58 | N2% v | Flowrate | 694.7 | Nm3 |
| Composition | 70 | Fe % w | Offgas to WGS (T4) | | | | 80.75 | CH4% v |
| | 30 | O % w | Flowrate | 874.7 | Nm3 | Composition | 14.25 | CO2% v |
| HBI (D4) | | | | 54.87 | CO % v | | 5.00 | N2% v |
| Flowrate | 1.870 | ton | | 20.58 | CO2% v | Flue Gas (F1) | | |
| | 95.5 | Fe % w | Composition | 4.57 | H2% v | Flowrate | 3585.0 | Nm3 |
| Composition | 3.5 | C % w | | 16.00 | H2O % v | | 63 | N2% v |
| | 1 | O % w | | 3.97 | N2% v | Composition | 22 | H2O % v |
| Total Steam Request (S1) | | | N2 removed (T5) | | | | 15 | CO2% v |
| Flowrate | 1373 | Nm3 | Flowrate | 1125.3 | Nm3 | | | |
| | | | Composition | 100 | N2% v | | | |

Offgas stream T3 is here passed through an optional purifying unit 28, wherein a certain amount of N₂ is removed as well as dust and other components. The output N₂ stream T5 is sent to N₂ stock 30 for possible valorization.

The residual offgas stream T4 exiting the purifying unit 28 mainly contains CO, CO₂, Hz, H₂O and is routed to a converter 32. The N₂ rejection quantity depends on the N₂ content in stream T3, and N₂ maximum acceptance in DR Plant 12. In the present embodiment the technology selected for the ironmaking plant 14 generates a significant amount of N₂. This may differ with other technologies.

Converter 32 (also referred to as hydrogen enrichment unit) is configured to convert CO and H₂O into CO₂ and H₂; and to output a CO₂-rich stream C1 and a separate Hz-rich stream HY1.

The stream HY1 typically consists of H₂, CO₂ and N₂ (amount of N₂ depends on ironmaking plant technology and presence of purifying unit 28). Apart from N₂, the main component of stream HY1 is H₂.

Due to the design of unit 32, typically most of the N₂ content of stream T4 will be directed in stream HY1. Accordingly, the stream C1 contains essentially CO₂, typically above 90%.

Since the separation of the two flows C1 and HY1 can be costly, one can opt for a unique output, composed by C1 and HY1 mixed together. Converter 32 is here configured to implement the water-gas shift reaction:

CO+H₂O [symbol] CO₂+H₂

Water-gas shift converters are well known in the art and will not be described. In order to maximize conversion of the CO present in the ironmaking plant offgas stream T4 (considering that it already contains H₂O), converter 32 can be fed with a steam stream S2 originating from a source 34 of steam produced from green energy.

It may be noted that, conventionally, the hydrogen-rich output stream of WGS converter is ‘product’ stream, whereas the CO₂-rich stream may be referred to as ‘tail gas’. The CO₂-rich stream is the tail gas of the converter 32; however in the context of the disclosure the CO₂-rich stream is not discarded, but valorized within the plant arrangement, namely into the direct reduction plant.

The two output streams of converter 32, i.e. the Hz-rich stream and CO₂-rich stream are fed to a methanation plant 36. The methanation plant 36 is configured to produce a gas stream NG1 having a quality and methane content comparable to natural gas. In the methanation plant the following reaction takes place:

CO₂+4H₂ [symbol] CH₄+H₂O

The produced gas stream NG1 has a quality and methane content that depends from the input streams; however, under certain conditions, it is similar to fossil natural gas, and may thus be referred to as natural gas, biogas or renewable natural gas, RNG. The natural gas stream NG1 preferably contains at least 65% v, preferably above 75, 80 or 85% v of CH₄.

Another output of plant 36 is steam S5, which is advantageously fed to a Solid Oxide Ectrolyzer Cell (SOEC) unit 38. SOEC Unit 38, is configured to transform H₂O into H₂, while removing excess 02 (which can be used elsewhere).

SOEC Unit 38 may optionally receive an additional green steam stream S3 from source 34, in order to increase the methane production.

As it is known in the art, a SOEC follows the same construction of a solid-oxide fuel cell, consisting of a fuel electrode (cathode), an oxygen electrode (anode) and a solid-oxide electrolyte. Steam is fed along the cathode side of the electrolyser cell. When a voltage is applied, the steam is reduced at the catalyst coated cathode-electrolyte interface and is reduced to form pure H₂ and oxygen ions. The hydrogen gas then remains on the cathode side and is collected at the exit as hydrogen fuel, while the oxygen ions are conducted through the solid and gas-thight electrolyte. At the electrolyte-anode interface, the oxygen ions are oxidized to form pure oxygen gas, which is collected at the surface of the anode. The SOEC operates at high temperature, generally 500 to 850° C.

The H₂ stream produced by SOEC unit 38 is fed to the methanation unit 36.

The biogas stream NG1 generated by the methanation unit 36 is sent to the DR plant 12 to be valorized. The biogas stream NG1 can be used for heating purposes and/or for metallurgical purposes, i.e. as reducing agent. The biogas stream NG1 can thus be part of a heating gas stream and/or part of a reducing gas stream, meaning that it can be mixed with other gases for either of these purposes.

In the above-mentioned case of where plant 12 comprises a shaft furnace, a reformer and a heat recovery system, then typically, most of the NG1 stream is added to the gas recirculating into plant 12; this has a metallurgical purpose. Indeed, the NG1 flow is introduced into the recirculation piping that recycles furnace gas via the heat recovery system and reformer. In the reformer, methane reacts with carbon dioxide and water vapour to form carbon monoxide and hydrogen (dry & steam reforming process are only an example). Other portions of NG1 are used as fuel (to sustain the reforming reactions required by the DR process), as well as direct injection into the shaft of plant 12, to boost carburization of the product D4, and to optimize the process.

The offgas (combustion flues—deriving from the combustion to sustain the reforming process) of the DR Plant 12 is routed to a stack 40 to be released to atmosphere.

Considering the layout of the present metallurgic plant, with biochar source and various gas treatments, the emissions of offgas stream F1 qualify as green or neutral.

Heat recovery systems in plant 12 allow producing a green steam stream S4 that is sent to source 34 for further use.

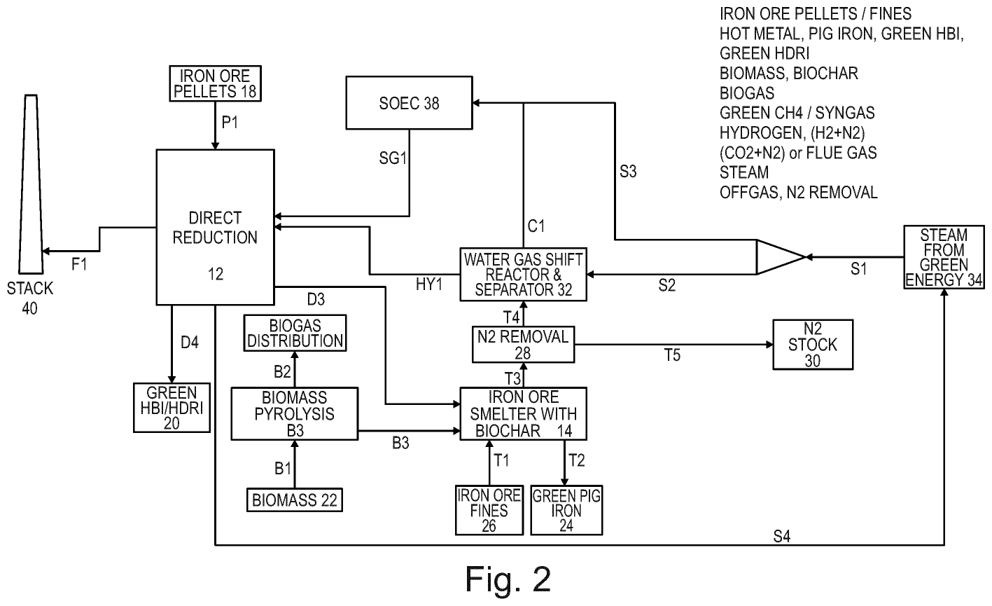

FIG. 2 illustrates a second embodiment of metallurgical plant 110, which mainly differs from the previous embodiment in that the DR plant 12 does not operate on the biogas stream (CH₄), but based on syngas. Its core equipment includes (not limiting to) a vertical shaft (with a top inlet and a bottom outlet), a heater and a CO₂ removal unit (not shown).

Similar to the first embodiment, biochar is produced in pyrolysis unit 16 and used for the production of pig iron in the ironmaking plant 14. Offgas from the ironmaking plant 14 is treated in optional purifying unit 28 and then in the hydrogen enrichment unit 32.

Here however the methanation unit 36 is omitted.

Hydrogen enrichment unit 32 produces the hydrogen-rich stream HY1, sent directly to the direct reduction plant 12. The CO₂ rich stream C1 output by hydrogen enrichment unit 32 is forwarded to the SOEC unit 38. In this case, SOEC unit 38 is operating in co-electrolysis mode, where both CO₂ and H₂O are transformed into CO and H₂, and oxygen is removed.

The outlet of SOEC unit 38 in this configuration is a syngas, stream SG1, composed mainly of CO and H₂. The ratio H₂ to CO in syngas stream SG1 may be between 2 and 4, e.g. of about 3. In embodiments (not shown), plant 12 may be equipped with a CO₂ removal system, and the CO₂ thus removed can be sent to SOEC unit 38, to be used as additional input flow.

Table 2 below gives an exemplary composition of the various gas flows for the embodiment of FIG. 2. It may be noted that this example corresponds to a situation where purifying unit 28 is inactive or omitted, i.e. nitrogen generated by the ironmaking plant 14 remains in the offgas to the hydrogen enrichment unit 32.

Depending on the N₂ content in stream T3/T4, one can implement one of the following actions:
1) accept a high N₂ content in stream T4 (and therefore in stream HY1), to make primarily use of HY1 for heating purposes in DR plant 12; or
2) remove the required quantity of N₂ from T3, and hence make joint use of HY1 and SG1 for both heating and reducing purposes in DR plant 12.

TABLE 2
Material flows of the configuration with Synlink for syngas DRI.

| Pig Iron (T2) | | | Steam from DR plant (S4) | | | CO2 from WGS (C1) | | |
|---|---|---|---|---|---|---|---|---|
| Flowrate | 1 | ton | Flowrate | 626.5 | Nm3 | Flowrate | 590.5 | Nm3 |
| Composition | 94.64 | Fe % w | Steam to WGS (S2) | | | Composition | 95 | CO2% v |
| | 3.5 | C % w | Flowrate | 340 | Nm3 | | 5 | N2% v |
| Iron Ore Fines (T1) | | | Steam to SOEC (S3) | | | H2 from WGS (HY1) | | |
| Flowrate | 1.433 | ton | Flowrate | 1652.851 | Nm3 | Flowrate | 1749.5 | Nm3 |
| Composition | 65 | Fe % w | Offgas (T3) | | | | 29.72 | H2% v |
| | 30 | O % w | Flowrate | 2000 | Nm3 | Composition | 5.66 | CO2% v |
| Fines from DR (D3) | | | | 24 | CO % v | | 64.62 | N2% v |
| Flowrate | 0.067 | ton | | 9 | CO2% v | SOEC out syngas (SG1) | | |
| | 95.5 | Fe % w | Composition | 2 | H2% v | Flowrate | 2243.4 | Nm3 |
| Composition | 3.5 | C % w | | 7 | H2O % v | | 20.01 | CO % v |
| | 1 | O % w | | 58 | N2% v | | 5.00 | CO2% v |
| Iron Ore (P1) | | | Offgas to WGS (T4) | | | Composition | 58.94 | H2% v |
| Flowrate | 2.830 | ton | Flowrate | 2000.0 | Nm3 | | 2.95 | H2O % v |
| Composition | 70 | Fe % w | | 24.00 | CO % v | | 1.32 | N2% v |
| | 30 | O % w | | 9.00 | CO2% v | Flue Gas (F1) | | |
| HBI (D4) | | | Composition | 2.00 | H2% v | Flowrate | 3486.3 | Nm3 |
| Flowrate | 2.096 | ton | | 7.00 | H2O % v | | 63 | N2% v |
| | 95.5 | Fe % w | | 58.00 | N2% v | Composition | 22 | H2O % v |
| Composition | 3.5 | C % w | N2 removed (T5) | | | | 15 | CO2% v |
| | 1 | O % w | Flowrate | 0 | Nm3 | | | |
| Total Steam Request (S1) | | | Composition | 100 | N2% v | | | |
| Flowrate | 1992.851 | Nm3 | | | | | | |

In the example of Table 2, N₂ in stream T3 is not removed: most of the stream HY1 (approx. 93%) is sent to DR plant 12 for heating purposes. The gas stream SG1 and the remaining part of the stream HY1 are thus directly fed to the DR plant 12 and are used therein as reducing gases.

No reformer is required.

It may be noted that alternative sources of heat (electricity) can be used in plant 12, that may change the gas balance indicated in the examples.

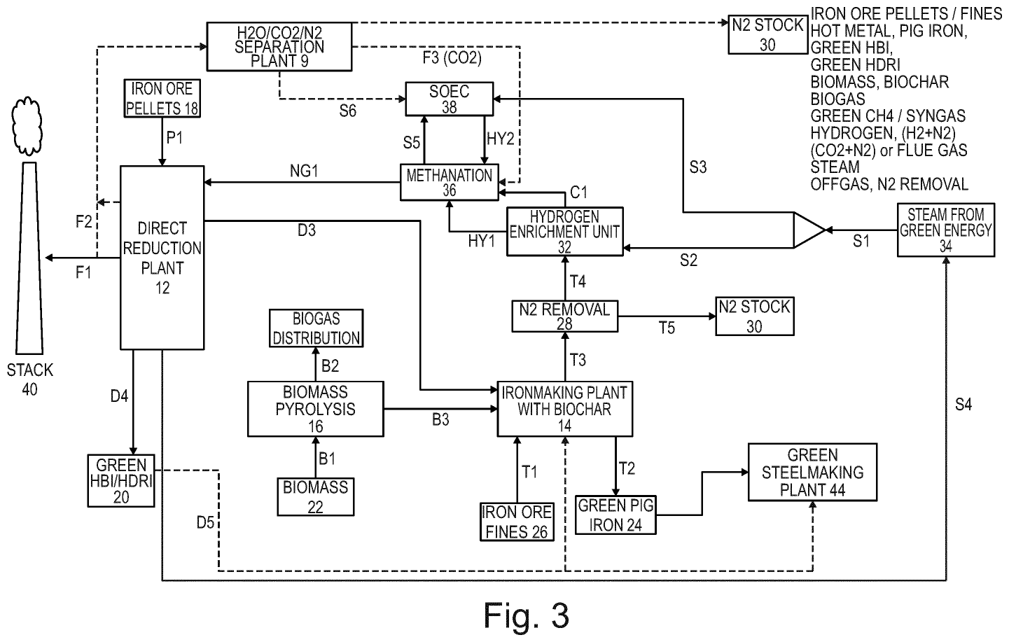

FIG. 3 shows a further embodiment of a metallurgical plant 210, which is a variant of the embodiment of FIG. 1. Compared to FIG. 1, plant 210 includes several options that can be implemented alone or in combination:
Option a). Part of the DRI/HBI/HDRI (stream D5) produced in the direct reduction plant may be sent to the ironmaking plant, as input raw material.
Option b). Part of the DRI/HBI/HDRI (stream D5) produced in the direct reduction plant may be sent to a green steelmaking plant (eg. BOF, EAF, SAF, others), as input raw material.
Option c). Part of the flue gas F1 leaving the DR plant, and/or part of the gas recirculating in DR plant 12, noted stream F2, may be sent to a H₂O/CO₂/N₂ separation plant, and the resulting steam—stream S6—is sent to SOEC unit 38, while the CO₂—noted F3—is sent to the methanation plant 36. If also N₂ is separated, it can be valorized. In such a way DR plant 12 can also be operated when the ironmaking plant 14 is not working (requiring only minimized external fuels/inputs). Depending on the total fuel/gas request of plant 12, the respective percentages of recycled stream F2 and of stream T3 can be regulated.

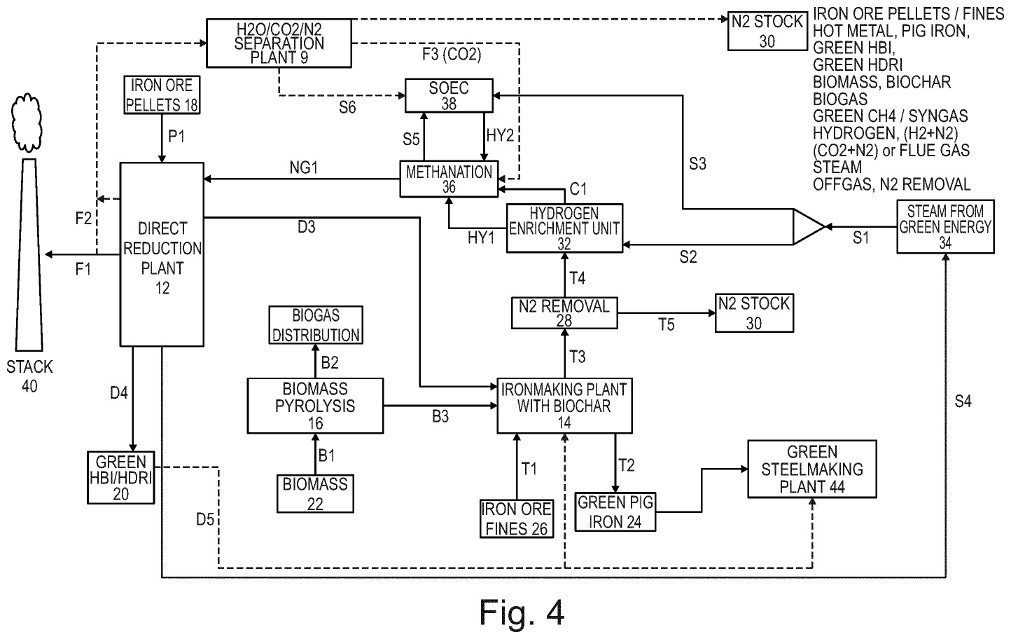

FIG. 4 shows a further embodiment of a metallurgical plant 310, which is a variant of the embodiment of FIG. 2. Compared to FIG. 2, plant 310 includes several options that can be implemented alone or in combination:
Option a). Part of the DRI/HBI/HDRI (stream D5) from the DR plant 12 is sent to the iron ore ironmaking plant 14, as input raw material.
Option b). Part of the DRI/HBI/HDRI (stream D5) DR plant 12 is sent to a green steelmaking plant 44, as input raw material.
Option c). Part of the flue gas leaving the DR plant 12 and/or part of the gas recirculating in plant 12, noted as stream F2, is sent to SOEC cells 38 for its co-electrolysis (a N₂ separation stage may be required). In such a way plant 12 can also be operated when ironmaking plant 14 is not working (requiring only minimized external fuels/inputs). Depending on the total fuel/gas request of plant 12, the respective percentages of recycled stream F2 and of stream T3 can be regulated.

1. A method of operating a metallurgic plant for producing iron products, the metallurgic plant including a direct reduction plant and an ironmaking plant, said method including the following steps:
feeding an iron ore charge into the direct reduction plant to produce direct reduced iron products,
operating the ironmaking plant to produce pig iron, wherein biochar is introduced into the ironmaking plant as reducing agent, and whereby the ironmaking plant generates offgas containing CO and CO₂, and
treating offgas from the ironmaking plant in a hydrogen enrichment unit to form a hydrogen-rich stream and a CO₂-rich stream,
wherein the hydrogen-rich stream is fed directly or indirectly to the direct reduction plant.

2. The method according to claim 1, wherein the CO₂-rich stream is converted, at least in part, to be valorized in the direct reduction plant, to syngas or natural gas.

3. The method according to claim 1, wherein dusts, fines, and other residues from the direct reduction plant are fed to the ironmaking plant as part of the charge to be melted therein.

4. The method according to claim 1, wherein at least part of the direct reduced products from the direct reduction implant are fed to the ironmaking plant and/or steelmaking plant as part of the charge to be melted therein, the direct reduced products including sponge iron and/or lumpy direct reduced products.

5. The method according to claim 1, wherein the hydrogen-rich stream is delivered to the direct reduction plant as part of a reducing gas stream.

6. The method according to claim 1, wherein the hydrogen-rich stream is delivered to the direct reduction plant as part of a fuel gas stream for heating purposes.

7. The method according to claim 5, wherein the CO₂-rich stream is fed to a water electrolysis unit, further supplied with a steam stream, to form a syngas stream that is delivered to the direct reduction plant.

8. The method according to claim 1, wherein the hydrogen-rich stream and the CO₂-rich stream are forwarded from the hydrogen enrichment unit to a methanation unit to form a methane stream that is forwarded to the direct reduction plant.

9. The method according to claim 8, wherein at least part of the methane stream is used in the direct reduction plant as part of a reducing gas stream.

10. The method according to claim 8, wherein the direct reduction plant comprises a shaft furnace and a reforming reactor, and wherein at least part of the methane stream is fed to the reforming reactor to generate a reducing gas, mainly hydrogen and carbon monoxide, forwarded to the shaft furnace to be used as part of a reducing gas stream.

11. The method according to claim 8, wherein at least part of the methane stream is used as part of a fuel gas stream.

12. The method according to claim 8, wherein a water electrolysis unit is associated with the methanation unit, a steam stream output from the methanation unit being fed to the electrolysis unit to form an auxiliary hydrogen stream that is fed back to the methanation unit.

13. The method according to claim 12, wherein a steam stream from a green energy is introduced into the water electrolysis unit; or wherein part of the offgas from the direct reduction plant is recycled towards the methanation unit, through a steam removal unit, the removed steam being fed to the water electrolysis unit.

14. (canceled)

15. The method according to claim 13, wherein the operation of the ironmaking plant is adjusted based on the amount of recycled offgas; or wherein the operation of the ironmaking plant is reduced or shut-off after reaching a steady state operation in the direct reduction plant.

16. (canceled)

17. The method according to claim 1, wherein the offgas stream from the ironmaking plant is treated in a nitrogen rejection unit before being forwarded to the hydrogen enrichment unit.

18. The method according to claim 1, wherein the hydrogen enrichment unit comprises a water-gas shift reactor.

19. The method according to claim 1, wherein a charge of said ironmaking plant comprises iron ore fines; and/or wherein steam from a green energy is introduced into the hydrogen enrichment unit and/or wherein at least part of the offgas from the direct reduction plant is released to the atmosphere.

20. (canceled)

21. (canceled)

22. The method according to claim 1, wherein the biochar is produced in a biomass pyrolysis unit from biomass material.

23. The method according to claim 1, wherein a portion of CO₂ removed in said direct reduction plant is forwarded to a water electrolysis unit, mixed with steam, to produce a syngas; and/or wherein the direct reduction plant is equipped with heat recovery systems generating steam.

24. (canceled)

25. A metallurgic plant for producing iron products, comprising:
a direct reduction plant configured for producing direct reduced products from an iron ore charge;
a biomass pyrolysis unit configured for generating biochar from biomass material;
a ironmaking plant configured to produce pig iron, said ironmaking plant using said biochar as reducing material and generating offgas; and
a hydrogen enrichment unit configured to receive the ironmaking plant offgas and form a hydrogen-rich stream and a CO2-rich stream;
wherein the hydrogen-rich stream is valorized directly or indirectly in the direct reduction plant.

26. The metallurgic plant according to claim 25, comprising means to convert CO₂ into a gas stream that is valorized in the direct reduction plant.

27. The metallurgic plant according to claim 26, comprising a methanation plant configured to receive the hydrogen-rich stream and a CO2-rich stream from the hydrogen enrichment unit and generate a biogas stream therefrom, a methane stream, that is forwarded to the direct reduction plant.

28. The metallurgic plant according to claim 27, comprising a water electrolysis unit associated with the methanation unit, a steam stream output from the methanation unit being fed to the electrolysis unit to form an auxiliary hydrogen stream that is fed back to the methanation unit.

29. The metallurgic plant according to claim 26, comprising a water electrolysis unit associated with the hydrogen enrichment unit, the water electrolysis unit being configured to receive the CO₂-rich stream as well as a steam stream, and to form a syngas stream that is delivered to the direct reduction plant.

30. The metallurgic plant according to claim 25, wherein the direct reduction plant includes a shaft furnace, a reformer and heat recovery systems; and/or wherein the direct reduction plant includes a shaft furnace, a heater and a CO₂ removal unit; and/or wherein the hydrogen enrichment unit comprises a water-gas shift reactor.

31. (canceled)

32. (canceled)

33. The metallurgic plant according to claim 25, wherein a nitrogen rejection unit is arranged on the flow of offgas from the ironmaking plant to hydrogen enrichment unit, or on the flow of the outlet of hydrogen enrichment plant.

34. The metallurgic plant according to claim 25, wherein the hydrogen enrichment unit is directly connected with the direct reduction plant to deliver at least part of the hydrogen-rich stream; and/or comprising means to forward dusts, fines, and other residues from the direct reduction plant to the ironmaking plant as part of the charge to be molten therein.

35. (canceled)
